(19) United States
(12) Patent Application Publication
(10) Pub. No.: US 2013/0154165 A1
(43) Pub. Date: Jun. 20, 2013

(54) Vacuum Forming Method for Leather Product

(71) Applicant: Tsung-Yu Wu, Taichung City (TW)

(72) Inventor: Tsung-Yu Wu, Taichung City (TW)

(21) Appl. No.: 13/542,707

(22) Filed: Jul. 6, 2012

(30) Foreign Application Priority Data
Dec. 15, 2011 (CN) 201110422300.5

(51) Int. Cl. B29C 59/02

(52) U.S. Cl. 264/571

(57) ABSTRACT

A vacuum forming method for a leather product, comprising the following steps: making a mold; heating a raw material of the leather product to a predetermined temperature and placing the raw material on a surface to form a pattern on the raw material, the pattern formed on the raw material corresponding to a pattern of the mold surface, wherein the raw material is disposed under a vacuum forming condition; and cooling the raw material of the leather product for making the leather product; wherein the predetermined temperature is between 150° C. to 200° C.; the vacuum forming condition is between 350 mmHg-700 mmHg for a vacuum degree. The present invention provides an easy manufacturing technique, which uses an easy-to-produce mold to form the leather product in one process, thereby providing the leather product with high emulation and high production efficiency.

### BACKGROUND OF THE INVENTION

1. Field of the Invention

The present invention relates to a vacuum forming method; more particularly, the present relates to a vacuum forming method for processing a leather product.

2. Description of the Related Art

As the average living standard improves, the demands for leather products also increase. People require more delicate, sophisticated designs and patterns for shoes, cloths, cases, bags (computer bag, computer/mobile phone leather case), or business leather accessories with luxurious feels. The line and pattern on a surface of the leather product are formed by using a mold to press the leather product, wherein the mold usually comprises a steel wheel, a silica gel wheel, or a nickel roller. However, using such a mold cannot achieve sophisticated lines/patterns and could only form shallow and common lines/patterns. Furthermore, all the patterns and lines are predetermined and formed on the mold in advance, and cannot be modified for different leather products or temporary needs. Besides, it requires several pressing steps to form different lines on different leather pieces, particularly 3D lines; and then to put all the pieces together to form a desired pattern; such that these forming steps performed manually or automatically by machines require a lot of time and costs with low production efficiency.

Vacuum forming, also known as thermoplastic forming, uses suction forces of a vacuum pump to let mold suck thermoplastic sheet materials to form various desired shapes; it can achieve advantages such as less investment on equipment, providing easy to produce mold, high manufacturability, and high production efficiency. However, vacuum forming is usually applied in plastic products and has never been used in other kinds of materials.

### SUMMARY OF THE INVENTION

It is an object of the present invention to solve the deficiencies of the prior art technique by providing an easy manufacturing technique, which uses an easy-to-produce mold to form the leather product in one process, thereby providing the leather product with high emulation and high production efficiency.

To achieve the abovementioned object, the present invention provides a vacuum forming method for a leather product, comprising the following steps:

Step 1: making a mold;

Step 2: heating a raw material of the leather product to a predetermined temperature and placing the raw material on a surface of the mold to form a pattern on the raw material, the pattern formed on the raw material corresponding to a pattern of the surface of the mold, wherein the raw material is disposed under a vacuum forming condition; and

Step 3: cooling the raw material of the leather product for making the leather product; wherein the predetermined temperature is between 150° C. to 200° C., and the vacuum forming condition is between 350 mmHg to 700 mmHg for a vacuum degree.

In order to meet the requirements of the different productions, the mold can be disposed as a panel to stay under the vacuum forming condition for 2 to 10 seconds; or the mold can be disposed as a roller, wherein a speed for the mold disposed as the roller is between 10 to 35 meter/second (m/s); it is noted that the mold can be disposed as a panel or a roller or a combination of both.

The mold can be a ceramic mold or a gas permeable metal mold according to the different requirements. The ceramic mold is made of a mixture of epoxy resin and quartz sand. The gas permeable metal mold is made by forming a plurality of micro pores on the gas permeable metal mold, or made of gas permeable metal.

The material of the leather product can be an animal leather, an artificial leather, or a compound leather. The animal leather, the artificial leather, or the compound leather is disposed on a base cloth having a thickness of 0.1 to 2.8 mm for enhancing the toughness of the animal leather, the artificial leather, or the compound leather. The animal leather can be a cattle hide, a sheepskin, or a pigskin. The artificial leather is made of polyvinyl chloride (PVC) or polyurethane (PU). The compound leather comprises an animal leather layer and a resin layer, the resin layer is made of a material selected from polyvinyl chloride (PVC), polyurethane (PU), polyethylene (PE), or thermoplastic polyurethane elastomer (TPU).

In order to enhance the forming property of the materials, a resin layer can be disposed on the compound leather, the resin layer is a coating layer coated on the animal leather layer via extrusion coating; or the resin layer is a coating layer coated on the animal leather layer via spray coating, brush coating, or roller coating; or the resin layer is a coating layer coated on the animal leather layer via silk screen coating; or the resin layer is a sheet material laminated on the animal leather layer via roller coating.

The leather product can be used for a shoe, a clothe, a case, a bag (such as a computer bag, a computer/mobile phone leather case, etc), or a business leather accessory.

Therefore, the present invention provides an easy vacuum forming technique, which uses an easy-to-produce mold to form the leather product in one process, thereby providing the leather product with high emulation and high production efficiency.

The present invention will be described in detail below with reference to the preferred embodiments.

### BRIEF DESCRIPTION OF THE DRAWINGS

None

### DETAILED DESCRIPTION OF THE PREFERRED EMBODIMENT

These and other objects and advantages of the present invention will become apparent from the following description of the accompanying drawings, which disclose several embodiments of the present invention. It is to be understood that the drawings are to be used for purposes of illustration only, and not as a definition of the invention.

In the first embodiment, heating an artificial PVC leather which is 0.2 mm to 3.0 mm thick to a temperature of 150° C. to 200° C., wherein the artificial PVC leather is not placed on a base cloth; then placing the artificial PVC leather on a surface of a panel type ceramic mold for vacuum forming under a vacuum degree of 400 mmHg to 600 mmHg for 2 to 8 seconds; thereby forming a pattern on the artificial PVC leather corresponding to that pattern of the panel type ceramic mold surface. After cooling, the artificial PVC leather is now prepared for making the leather product.

In the second embodiment, heating a material combining an animal leather which is 0.1 mm to 3.0 mm thick and an PVC coating layer to a temperature of 150 to 200 ; and then placing the material on a surface of a roller type ceramic mold under a vacuum degree of 350 mmHg to 600 mmHg, wherein the roller type ceramic mold is moving with a speed of 10 to 35 m/s, allowing the surface of the animal leather combining the PVC coating layer to form a pattern corresponding to that pattern of the roller type ceramic mold surface. After cooling, the material combining the animal leather and the PVC coating layer is now prepared for making the leather product.

Meanwhile, heating the material combining the animal leather which is 0.1 mm to 3.0 mm thick and the PVC coating layer to a temperature of 150° C. to 200° C.; and then placing the material on a surface of a panel type ceramic mold for vacuum forming under a vacuum degree of 350 mmHg to 600 mmHg for 2 to 8 seconds; thereby forming a pattern on the surface of the animal leather and the PVC coating layer, and the pattern of the animal leather and the PVC coating layer is corresponding to that pattern of the mold surface. After cooling, the material combining the animal leather and the artificial PVC leather is now prepared for making the leather product.

Since the roller type ceramic mold can provide larger quantities, it is more suitable for mass/batch production. On the other hand, the panel type ceramic mold can provide leather products having specific sizes or shapes when used together with the roller type ceramic mold.

In the third embodiment, heating an artificial PU leather which is 0.4 mm to 3.0 mm thick to a temperature of 120° C. to 170° C.; and then placing the artificial PU leather on a surface of a roller type ceramic mold under a vacuum degree of 450 mmHg to 700 mmHg, wherein the roller type ceramic mold is moving with a speed of 10 to 30 m/s, allowing the surface of the artificial PU leather to form a pattern corresponding to that of the roller type ceramic mold surface. After cooling, the artificial PU leather is now prepared for making the leather product.

In the fourth embodiment, heating a material combining an animal leather which is 0.1 mm to 3.0 mm thick and an PU coating layer to a temperature of 120° C. to 170° C.; and then placing the material on a surface of a roller type ceramic mold under a vacuum degree of 400 mmHg to 600 mmHg, wherein the roller type ceramic mold is moving with a speed of 10 to 30 m/s, allowing the surface of the animal leather combining the PU coating layer to form a pattern corresponding to that pattern of the roller type ceramic mold surface. After cooling, the material combining the animal leather and the PU coating layer is now prepared for making the leather product.

In the fifth embodiment, heating an artificial TPU leather which is 0.2 mm to 3.0 mm to a temperature of 100° C. to 170° C.; and placing the artificial TPU leather on a surface of a panel type ceramic mold for vacuum forming under a vacuum degree of 400mmHg to 600mmHg for 3 to 10 seconds; thereby forming a pattern on the surface of the artificial TPU leather corresponding to that pattern of the mold surface. After cooling, the artificial TPU leather is now prepared for making the leather product.

In the sixth embodiment, heating a material combining an animal leather which is 0.1 mm to 3.0 mm thick and an TPU coating layer to a temperature of 100° C. to 170° C.; and then placing the material on a surface of a roller type ceramic mold under a vacuum degree of 350 mmHg to 650 mmHg, wherein the roller type ceramic mold is moving with a speed of 10 to 30 m/s, allowing the surface of the animal leather combining the TPU coating layer to form a pattern corresponding to that pattern of the roller type ceramic mold surface. After cooling, the material combining the animal leather and the TPU coating layer is now prepared for making the leather product.

In the seventh embodiment, heating an artificial PVC leather which is 0.2 mm to 3.0 mm thick to a temperature of 150° C. to 200° C., wherein the artificial PVC leather is not placed on a base cloth; and then placing the artificial PVC leather combining the base cloth on a surface of a panel type ceramic mold for vacuum forming under a vacuum degree of 450 mmHg to 650 mmHg for 2 to 6 seconds; thereby forming a pattern on the surface of the artificial PVC leather corresponding to that pattern of the mold surface. After cooling, the artificial PVC leather is now prepared for making the leather product.

It is noted that the usual thickness of the base cloth is between 0.1 to 2.8 mm.

From the embodiments described above, it is known that the present invention provides a vacuum forming method for a leather product. The method comprises the following steps:

Step 1: making a mold;

Step 2: heating a raw material of the leather product to a predetermined temperature and placing the raw material on a surface of the mold to form a pattern on the raw material, the pattern formed on the raw material corresponding to a pattern of the surface of the mold, wherein the raw material is disposed under a vacuum forming condition; and

Step 3: cooling the raw material of the leather product for making the leather product; wherein the predetermined temperature is between 150° C. to 200° C., and the vacuum forming condition is between 350 mmHg-700 mmHg for a vacuum degree.

In order to meet the requirements of the different productions, the mold can be disposed as a panel to stay under the vacuum forming condition for 2 to 10 seconds; or the mold can be disposed as a roller, wherein a speed for the mold disposed as the roller is between 10 to 35 meter/second (m/s); it is noted that the mold can be disposed as a panel or a roller or a combination of both.

The mold can be a ceramic mold or a gas permeable metal mold according to the different requirements. The ceramic mold is made of mixture of epoxy resin and quartz sand. Since the quartz sand is intrinsically porous, it can provide evenly distributed suction force to the material disposed on the surface of the ceramic mold during the vacuum forming process. The pattern formed on the material tends to have high emulation. The gas permeable metal mold is made by forming a plurality of micro pores on the gas permeable metal mold, or the gas permeable metal mold is made of a gas permeable metal for achieving the best vacuum forming results.

The lines/patterns on the mold can be uniform or varied according to the design requirements. The multiple lines/patterns can be disposed on a same plane or on the different planes in order to be seen as scattering on the different heights; thereby enhancing the three-dimensional effect and emulation of the lines/patterns on the material with better visual effects.

About the manufacturing method of the mold, please refer to the disclosure of Chinese patent file Publication NO.CN1236763A.

The material of the leather product can be an animal leather, an artificial leather, or a compound leather. The animal leather, the artificial leather, or the compound leather is disposed on a base cloth having a thickness of 0.1 to 2.8 mm for enhancing the toughness of the animal leather, the artificial leather, or the compound leather. The animal leather can be a cattle hide, a sheepskin, or a pigskin. The artificial leather is made of polyvinyl chloride (PVC) or polyurethane (PU). The compound leather comprises an animal leather layer and a resin layer, the resin layer is made of a material selected from polyvinyl chloride (PVC), polyurethane (PU), polyethylene (PE), or thermoplastic polyurethane elastomer (TPU).

In order to enhance the forming property of the materials, a resin layer can be disposed on the compound leather, the resin layer is a coating layer coated on the animal leather layer via extrusion coating; or the resin layer is a coating layer coated on the animal leather layer via spray coating, brush coating, or roller coating; or the resin layer is a coating layer coated on the animal leather layer via silk screen coating; or the resin layer is a sheet material laminated on the animal leather layer via roller coating.

As described above, the leather product can used for shoes, clothes, a case, a bag (such as a computer bag, a computer/mobile phone leather case, etc), or a business leather accessory.

Therefore, the present invention provides an easy vacuum forming technique, which uses an easy-to-produce mold to form the leather product in one process, thereby providing the leather product with high emulation and high production efficiency.

It is noted that the above-mentioned embodiments are only for illustration. It is intended that the present invention cover modifications and variations of this invention provided they fall within the scope of the following claims and their equivalents. Therefore, it will be apparent to those skilled in the art that various modifications and variations can be made to the structure of the present invention without departing from the scope or spirit of the invention.

What is claimed is:

1. A vacuum forming method for a leather product, the vacuum forming method comprising:
Step 1: making a mold;
Step 2: heating a raw material of the leather product to a predetermined temperature and placing the raw material on a surface of the mold to form a pattern on the raw material, the pattern formed on the raw material corresponding to a pattern of the surface of the mold, wherein the raw material is disposed under a vacuum forming condition; and
Step 3: cooling the raw material of the leather product for making the leather product;
wherein the predetermined temperature is between 150° C. to 200° C., and the vacuum forming condition is between 350 mmHg to 700 mmHg for a vacuum degree.

2. The vacuum forming method for the leather product as claimed in claim 1, wherein the mold can be disposed as a panel, a time for the mold disposed to stay under the vacuum forming condition is between 2 to 10 seconds; or the mold can be disposed as a roller, a speed for the mold disposed is between 10 to 35 meter/second (m/s); wherein in the Step 2, the mold can be disposed as a panel, a roller, or a combination of the panel and the roller.

3. The vacuum forming method for the leather product as claimed in claim 2, wherein the mold can be a ceramic mold or a gas permeable metal mold.

4. The vacuum forming method for the leather product as claimed in claim 3, wherein the ceramic mold is made of a mixture of epoxy resin and quartz sand.

5. The vacuum forming method for the leather product as claimed in claim 3, wherein the gas permeable metal mold is made by forming a plurality of micro pores on the gas permeable metal mold, or made of gas permeable metal.

6. The vacuum forming method for the leather product as claimed in claim 1, wherein the material of the leather product can be an animal leather, an artificial leather, or a compound leather.

7. The vacuum forming method for the leather product as claimed in claim 6, wherein the animal leather, the artificial leather or the compound leather is disposed on a base cloth, and a thickness of the base cloth is between 0.1 to 2.8 mm.

8. The vacuum forming method for the leather product as claimed in claim 6, wherein the animal leather can be a cattle hide, a sheepskin, or a pigskin.

9. The vacuum forming method for the leather product as claimed in claim 6, wherein the artificial leather is made of polyvinyl chloride or polyurethane.

10. The vacuum forming method for the leather product as claimed in claim 6, wherein the compound leather comprises an animal leather layer and a resin layer, the resin layer is made of a material selected from polyvinyl chloride, polyurethane, polyethylene, or thermoplastic polyurethane elastomer.

11. The vacuum forming method for the leather product as claimed in claim 10, wherein the resin layer is a coating layer coated on the animal leather layer via extrusion coating.

12. The vacuum forming method for the leather product as claimed in claim 10, wherein the resin layer is a coating layer coated on the animal leather layer via spray coating, brush coating, or roller coating.

13. The vacuum forming method for the leather product as claimed in claim 10, wherein the resin layer is a coating layer coated on the animal leather layer via silk screen coating.

14. The vacuum forming method for the leather product as claimed in claim 10, wherein the resin layer is a sheet material laminated on the animal leather layer via roller coating.

15. The vacuum forming method for the leather product as claimed in claim 1, wherein the leather product is used for a shoe, a cloth, a case, a bag (such as a computer bag and a computer/mobile phone leather case), or a business leather accessory.
